(19) United States
(12) Patent Application Publication
(10) Pub. No.: US 2026/0225803 A1
(43) Pub. Date: Aug. 6, 2026

(54) TARGET OBJECT CONVEYING SYSTEM AND METHOD, DOCKING DEVICE, AND CONVEYING DEVICE

(71) Applicant: BEIJING GEEKPLUS TECHNOLOGY CO., LTD., Beijing (CN)

(72) Inventors: Mengdi WANG, Beijing (CN); Dong ZANG, Beijing (CN); Xu WANG, Beijing (CN); Yuxin AN, Beijing (CN)

(21) Appl. No.: 19/146,691

(22) PCT Filed: Jan. 5, 2024
(86) PCT No.: PCT/CN2024/070773

§ 371 Date: Jul. 9, 2025

(30) Foreign Application Priority Data
Jan. 9, 2023 (CN) 202310027830.2
Jan. 9, 2023 (CN) 202320061593.7
Feb. 1, 2023 (CN) 202320237559.0

(51) Int. Cl. B65G 1/04; B65G 47/04; B65G 67/24; B65G 69/28; B66F 9/065

(52) U.S. Cl. CPC B65G 1/0485; B65G 47/04; B65G 67/24; B65G 69/2805; B66F 9/065

(57) ABSTRACT

A target object conveying system includes: a handling device; a conveying device; and a docking device, arranged at an end of the conveying device and configured to transfer a target object between the conveying device and the handling device, the docking device is provided with a power transmission mechanism in a comb-tooth structure; the handling device is provided with a top plate in a comb-tooth structure adapted to the power transmission mechanism, and the comb-tooth structures are configured to dock the top plate of the handling device with the power transmission mechanism; and the conveying device is configured to provide a conveying path for conveying the target object between the conveying device and an operation area.

### CROSS-REFERENCE TO RELATED APPLICATIONS

This application is a national stage entry under 35 U.S.C. § 371 of International Application No. PCT/CN 2024/070773, filed Jan. 5, 2024, which claims priority to Chinese Patent Application No. 202310027830.2, filed Jan. 9, 2023, Chinese Patent Application No. 202320061593.7, filed Jan. 9, 2023, and Chinese Patent Application No. 202320237559.0, filed Feb. 1, 2023. The entire disclosures of the above identified applications are hereby incorporated herein by reference.

### FIELD

The present disclosure relates to the technical field of warehousing and logistics, and more particularly to a target object conveying system and method, a docking device and a conveying device.

### BACKGROUND

In a logistics center, the speed and accuracy of picking operations often determine the efficiency of order fulfillment and the quality of customer service. Picking is an operation that workers pick goods from racks according to orders. In order to reduce the time for workers to look for goods and improve operation efficiency, a goods-to-person picking system came into being. The goods-to-person picking system includes a box-to-person picking system and a rack-to-person picking system.

In the box-to-person picking system, a handling device takes a box from a rack and transports it to a picking operation area. An operator picks required goods from the box loaded by the handling device, and then the handling device leaves the picking operation area to perform a next task.

### SUMMARY

Embodiments of the present disclosure provide a target object conveying system, which includes a handling device, a conveying device, and a docking device arranged at an end of the conveying device; the docking device is configured to transfer a target object between the conveying device and the handling device, the docking device is provided with a power transmission mechanism in a comb-tooth structure, the handling device is provided with a top plate in a comb-tooth structure adapted to the power transmission mechanism, and the comb-tooth structures are configured to dock the top plate of the handling device with the power transmission mechanism; and the conveying device is configured to provide a conveying path for conveying the target object between the conveying device and an operation area.

Embodiments of the present disclosure provide a warehouse, which includes: a warehousing area, a first storage area for storing a target object, a second storage area for storing a target object to be shipped out, an operation area and a shipping-out area; a handling device is configured to transfer the target object to be shipped out among target objects in the warehousing area to the second storage area, and transfer remaining target objects in the warehousing area other than the target object to be shipped out to the first storage area, according to a preset storage strategy; the handling device is configured to transfer the target object to be shipped out from the second storage area to the operation area, the operation area is deployed with at least one target object conveying system as described in the above embodiment, and the target object conveying system is configured to perform picking of the target object to be shipped out to obtain a picked target object; and the handling device is configured to transfer the picked target object to the shipping-out area.

Embodiments of the present disclosure provide a target object conveying method, which is applied to a target object conveying system including a handling device, a conveying device and a docking device arranged at an end of the conveying device. The method includes: transferring, by the docking device, a target object between the conveying device and the handling device, where the docking device is provided with a power transmission mechanism in a comb-tooth structure; and providing, by the conveying device, a conveying path for conveying the target object between the conveying device and an operation area. The handling device has a top plate in a comb-tooth structure adapted to the power transmission mechanism to dock the top plate of the handling device with the power transmission mechanism.

### BRIEF DESCRIPTION OF THE DRAWINGS

In order to clearly illustrate the technical solutions of embodiments of the present disclosure, drawings to be used for the description of embodiments of the present disclosure will be briefly introduced below. Apparently, the drawings described below are only some embodiments of the present disclosure, and other drawings may be obtained by those ordinarily skilled in the related art based on these drawings without creative work.

FIG. 1 is a schematic diagram of a target object conveying system according to embodiments of the present disclosure;

FIG. 2a is a side view of a handling device in a target object conveying system according to embodiments of the present disclosure;

FIG. 2b is a front view of a handling device in a target object conveying system according to embodiments of the present disclosure;

FIG. 2c is a top view of a handling device in a target object conveying system according to embodiments of the present disclosure;

FIG. 3a is a schematic diagram showing docking between a docking device and a handling device in a target object conveying system according to embodiments of the present disclosure;

FIG. 3b is a schematic diagram showing completion of docking between a docking device and a handling device in a target object conveying system according to embodiments of the present disclosure;

FIG. 3c is a top view showing docking of a docking device and a handling device in a target object conveying system according to embodiments of the present disclosure;

FIG. 4 is a schematic diagram showing a docking path for a handling device and a docking device in a target object conveying system according to embodiments of the present disclosure;

FIG. 5 is a first schematic diagram showing an application of a target object conveying system in a picking and order processing scenario according to embodiments of the present disclosure;

FIG. 6 is a schematic diagram showing an application of a target object conveying system in a racking scenario according to embodiments of the present disclosure;

FIG. 7 is a second schematic diagram showing an application of a target object conveying system in a picking and order processing scenario according to embodiments of the present disclosure;

FIG. 8 is a schematic flow chart diagram showing an application of a target object conveying system in a target object warehouse according to embodiments of the present disclosure;

FIG. 9 is a schematic flow chart diagram of a target object conveying method according to embodiments of the present disclosure;

FIG. 10 is a schematic diagram of a docking device according to embodiments of the present disclosure;

FIG. 11 is a schematic diagram showing an overall structure of a conveying device according to embodiments of the present disclosure;

FIG. 12 is a schematic diagram of a bearing device and a connecting rod mechanism according to embodiments of the present disclosure;

FIG. 13 is a schematic diagram of a bearing device and a lifting mechanism according to embodiments of the present disclosure;

FIG. 14 is a schematic diagram of a bearing device, a first lifting mechanism, and a second lifting mechanism according to embodiments of the present disclosure;

FIG. 15 is a schematic diagram of a bearing device and a scissor-type lifting mechanism according to embodiments of the present disclosure;

FIG. 16 is another schematic diagram of a bearing device and a scissor-type lifting mechanism according to embodiments of the present disclosure;

FIG. 17 is a schematic diagram of a bearing device and an angle adjustment mechanism according to embodiments of the present disclosure;

FIG. 18 is a schematic diagram of a screw-sleeve assembly according to embodiments of the present disclosure;

FIG. 19 is a schematic diagram of a knob assembly according to embodiments of the present disclosure;

FIG. 20 is a schematic diagram of a bearing device and an adjusting device with a connecting part according to embodiments of the present disclosure;

FIG. 21 is a schematic diagram showing an overall structure of a target object conveying system according to embodiments of the present disclosure;

FIG. 22 is a schematic diagram showing an overall structure of a target object conveying system according to embodiments of the present disclosure; and FIG. 23 is a schematic block diagram of a computing device according to embodiments of the present disclosure.

### DETAILED DESCRIPTION

Details are described in the following description to facilitate understanding of this specification. However, this specification may be implemented in many other ways than those described herein, and those skilled in the art may make similar extension without departing from the connotation of this specification, so this specification is not limited to the implementations disclosed below.

Terms used in one or more embodiments of this specification are for the purpose of describing specific embodiments, and are not intended to limit the one or more embodiments of this specification. As used in one or more embodiments of this specification and the appended claims, “a/an”, “said” and “the” in singular forms are intended to include plural forms, unless clearly indicated in the context otherwise. It should also be understood that, the term “and/or” used in one or more embodiments of this specification represents and contains any one or any possible combinations of one or more associated items listed.

It should be understood that, although terms such as “first” and “second” may be used in one or more embodiments of this specification for describing various information, these information should not be limited by these terms. These terms are used for distinguishing information of the same type from each other. For example, the “first” may also be referred to as the “second”, and similarly, the “second” may also be referred to as the “first”, without departing from the scope of one or more embodiments of this specification. Depending on the context, the term “if” as used herein may be construed to mean “when” or “upon” or “in response to determining”.

In this specification, a target object conveying system is provided, and this specification involves three kinds of target object conveying systems, a warehouse, a target object conveying method, a docking device, a computing device, and a computer-readable storage medium, which will be described respectively in detail in the following embodiments.

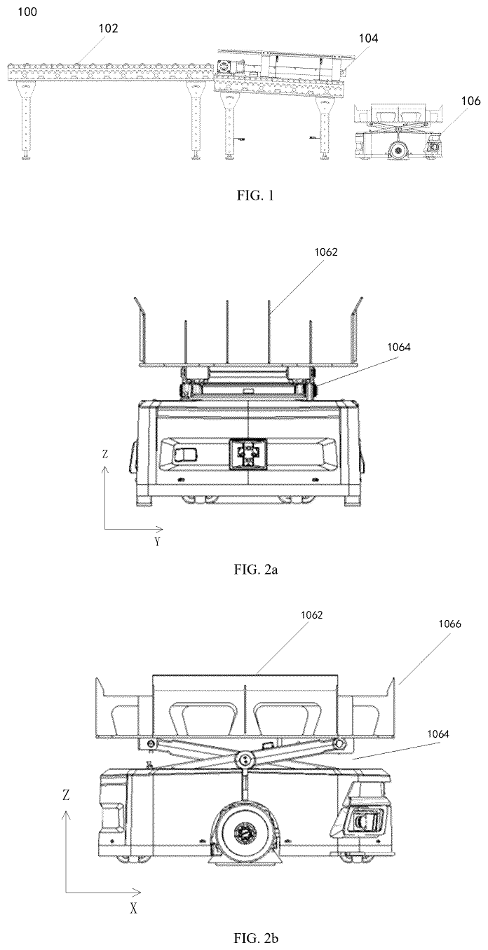

Referring to FIG. 1, and FIG. 1 shows a schematic diagram of a target object conveying system according to embodiments of the present disclosure. As shown in FIG. 1, the target object conveying system 100 includes a conveying device 102, a docking device 104 arranged at an end of the conveying device 102, and a handling device 106.

The docking device 104 is configured to transfer a target object between the conveying device 102 and the handling device 106, the docking device 104 is provided with a power transmission mechanism, the power transmission mechanism may be in a comb-tooth structure, and top plate of the handling device 106 has a comb-tooth structure adapted to the power transmission mechanism, so as to dock the top plate of the handling device 106 with the power transmission mechanism.

The conveying device 102 is configured to provide a conveying path for conveying the target object between the conveying device 102 and an operation area.

The handling device 106 may obtain a target object to be transported from a rack and realize the transfer of the target object between the rack and the operation area. In an embodiment, the handling device 106 may be a robot for transporting the target object. FIG. 2a shows a side view of a handling device in a target object conveying system according to embodiments of the present disclosure, FIG. 2b shows a front view of the handling device in the target object conveying system according to embodiments of the present disclosure, and FIG. 2c shows a top view of the handling device in the target object conveying system according to embodiments of the present disclosure. As shown in FIG. 2a, FIG. 2b and FIG. 2c, the handling device 106 may include a top plate 1062 in a comb-tooth structure. In an embodiment, at least two pieces of plates are arranged in sequence, with a gap present between any two adjacent plates. A lifting component 1064 is disposed below the top plate 1062, and the top plate 1062 may be raised or lowered in height by adjusting the lifting component 1064. In addition, a first limiting assembly 1066 is provided on the top plate 1062 of the handling device to prevent the target object to be transported from falling from the top plate 1062.

For example, a plurality of top plates 1062 in the comb-tooth structure on the handling device 106 may be arranged at intervals along a width direction of the handling device 106 (refer to a y direction as shown in FIG. 2c), and a bottom end of each top plate 1062 is fixed on the lifting component 1064, and a top end of each top plate 1062 extends upwards as a free end.

The first limiting assembly 1066 may be blocking blocks disposed at both ends of the top plate along a length direction (refer to an x direction as shown in FIG. 2b), and the blocking blocks are slightly higher than the top plate in height to prevent the target object to be transported from falling from the top plate.

After the handling device 106 reaches a docking position, the top plate 1062 is inserted into the power transmission mechanism 1042 at the docking position to transfer the target object between the top plate 1062 and the power transmission mechanism 1042.

The docking position may be understood as a preset position at which the handling device may be docked with the docking device. When the handling device is located at the docking position, docking with the docking device may be achieved.

The target object in an embodiment may be a receptacle for holding goods, materials and other items, including a plastic box, a carton, a paper box, a plastic basket and other cargo boxes; it may also be an original box, such as goods with an original packaging box or packaging case; and it may also be goods or cargoes themselves.

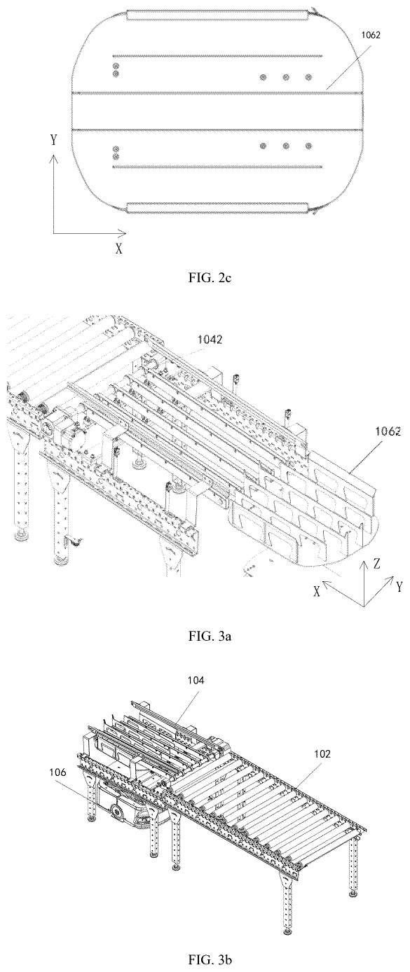

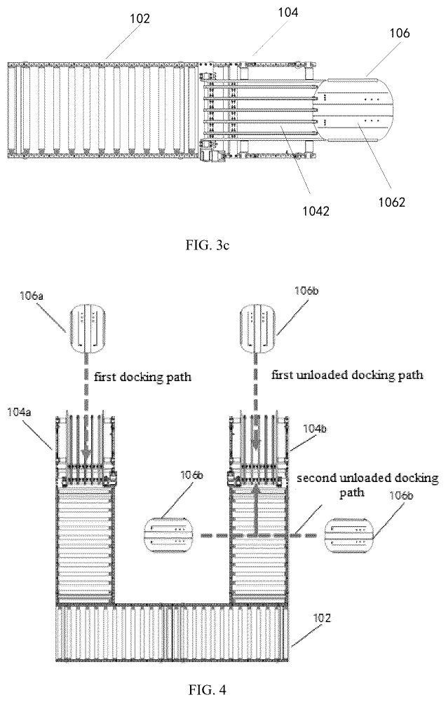

Further, FIG. 3a is a schematic diagram showing docking between a docking device and a handling device in a target object conveying system according to embodiments of the present disclosure, FIG. 3b is a schematic diagram showing completion of docking between a docking device and a handling device in a target object conveying system according to embodiments of the present disclosure, and FIG. 3c is a top view showing docking of a docking device and a handling device in a target object conveying system according to embodiments of the present disclosure. As shown in FIG. 3a, FIG. 3b and FIG. 3c, the docking device 104 is provided with a power transmission mechanism 1042 in a comb-tooth structure, the top plate 1062 of the handling device 106 has an adapted comb-tooth structure, the handling device 106 is located below the docking device 104, and the docking device 104 is in contact with the conveying device 102. The power transmission mechanism 1042 may be composed of at least two conveyor belts, and a gap is present between each two conveyor belts, so that the top plate 1062 in the comb-tooth structure may be inserted into the gap to achieve the docking between the handling device 106 and the docking device 104.

For example, the gaps of the comb-tooth structure of the above-mentioned handling device 106 extend along the x direction, and the comb-tooth structure of the power transmission mechanism 1042 is formed by a plurality of conveyor belts extending along the x direction, that is, the gaps of the corresponding comb-tooth structure extend along the x direction, so that the handling device 106 can be engaged with the docking device 104, thereby realizing the transfer of the target object on the handling device 106 and the docking device 104.

Based on this, the docking device 104 is able to transfer the target object to be transported from the top plate 1062 of the handling device 106 to the power transmission mechanism 1042. That is, after the handling device 106 and the docking device 104 are docked, the target object placed on the top plate 1062 may be transferred to the power transmission mechanism 1042, thereby completing the transfer of the target object to be transported. In addition, the docking device 104 can also transfer the target object placed on the power transmission mechanism 1042 to the handling device 106

In a case of transferring the target object from the handling device 106 to the docking device 104, after the handling device 106 reaches the docking position, the top plate 1062 is inserted into the power transmission mechanism 1042 at the docking position, and the top plate 1062 is lowered by a first preset height to transfer the target object from the top plate 1062 to the power transmission mechanism 1042.

The first preset height, i.e., a moving height of the top plate 1062 of the handling device 106 when the docking device 104 and the handling device 106 are docked, may be preset. The moving height may be an ascending height or a descending height. For example, in a case where the target object is transferred from the handling device 106 to the docking device 104, the first preset height is the descending height. In a case where the target object is transferred from the docking device 104 to the handling device 106, the first preset height is the ascending height.

Based on this, in the case where the target object is transferred from the handling device 106 to the docking device 104, the target object is located at the top plate 1062 of the handling device 106. After the handling device 106 moves to the docking position, the top plate 1062 is inserted into the power transmission mechanism 1042 at the docking position. At this time, the top plate 1062 is lowered by the first preset height to make the target object supported on the power transmission mechanism 1042, such as on the conveyor belts, so that the target object originally located on the top plate 1062 is left on the power transmission mechanism 1042, thereby realizing the transfer of the target object.

It should be noted that in the case where the target object is transferred from the handling device 106 to the docking device 104, since the target object is located at the top plate 1062 of the handling device 106, the top plate 1062 may be higher than the power transmission mechanism 1042 in height before the handling device 106 is inserted into the power transmission mechanism 1042, i.e., at the docking position, so that when the top plate 1062 carrying the target object are horizontally inserted into the power transmission mechanism 1042, the target object will not come into contact with the conveyor belts and thus will not move on the top plate 1062 due to friction.

Accordingly, in the case where the target object is transferred from the docking device 104 to the handling device 106, after the handling device 106 reaches the docking position, the top plate 1062 is inserted into the power transmission mechanism 1042 at the docking position, and the top plate is raised by the first preset height to support the target object on the top plate 1062, so that the target object located at the power transmission mechanism 1042 is transferred to the top plate 1062.

It should be noted that, in the case where the target object is transferred from the docking device 104 to the handling device 106, since the target object is located on the power transmission mechanism 1042, the top plate 1062 of the handling device 106 may be lower than the power transmission mechanism 1042 in height before the handling device 106 is inserted into the power transmission mechanism 1042, i.e., at the docking position, so that when the top plate 1062 is horizontally inserted into the power transmission mechanism 1042, the target object located on the power transmission mechanism 1042 will not come into contact with the top plate 1062, and thus will not move on the power transmission mechanism 1042 due to friction.

In the case where the target object is transferred from the docking device 104 to the handling device 106, the target object is located at the power transmission mechanism 1042 of the docking device 104. After the handling device 106 reaches the docking position, the top plate 1062 is inserted into the power transmission mechanism 1042 at the docking position. At this time, the top plate 1062 is raised by the first preset height, so that the target object originally located at the power transmission mechanism 1042 is transferred to the top plate 1062. The handling device 106 moves along a predetermined route and leaves the docking device 104, to achieve the removal of the target object from the docking device 104.

In summary, by setting the first preset height and raising or lowering the top plate 1062 by the first preset height, the transfer of the target object is achieved.

In order to realize the complete picking of goods in the target object, the docking device 104 includes a first docking device 104a and a second docking device 104b, the first docking device 104a is arranged at an inlet end of the conveying device 102, and the second docking device 104b is arranged at an outlet end of the conveying device 102.

Correspondingly, the conveying device 102 is configured to provide a conveying path for the target object after passing through the operation area to leave towards the outlet end.

The second docking device 104b is configured to dock with a second handling device 106b at a second docking position after the target object arrives at the second docking position, and transfer the target object to the second handling device 106b.

Further, after the target object leaves the operation area, the second docking device 104 comes into contact with the outlet end of the conveying device 102.

For example, the first docking device 104a and the second docking device 104b may be the same docking devices 104, that is, the first docking device 104a and the second docking device 104b have the same structure, and the description of the first docking device 104a in the present disclosure is applicable to the second docking device 104b. The terms “first” and “second” are used to indicate that the number of docking devices 104 in the target object conveying system is two, and are used to distinguish the two docking devices 104 at the inlet end and the outlet end of the conveying device 102. Correspondingly, the first handling device 106a and the second handling device 106b may be the same handling devices 106, that is, the first handling device 106a and the second handling device 106b have the same structure.

For example, after the first handling device 106a loaded with the target object to be transported arrives at the first docking position, the first handling device 106a docks with the first docking device 104a at the first docking position, and transfers the target object to be transported from the first handling device 106a to the first docking device 104a, the first docking device 104a then transfers the target object to be transported to the inlet end of the conveying device 102, the conveying device 102 then transfers the target object from the inlet end to the operation area for an operator in the operation area to pick goods in the target object to be transported. After the picking is finished, the conveying device 102 transfers the target object to the outlet end and further transfers the target object to the second docking device 104b at the outlet end. The second handling device 106b moves to the second docking position to dock with the second docking device 104b. After the target object arrives at the second docking position, the second docking device 104b transfers the target object to the second handling device 106b, and the second handling device 106b loads the target object and leaves the operation area to perform the next task, such as putting the target object back to the rack. During this process, the handling device 106 does not need to wait for the operator's picking operation in the operation area. Instead, the handling device 106 leaves directly after transferring the target object to the first docking device 104a, or moves to the second docking position to retrieve the target object which has been subjected to the picking operation, such as putting the target object back to the rack, thereby improving the operation efficiency.

In order to enable the target object to be smoothly transferred from the first docking device 104a to the conveying device 102, after the first handling device 106a loaded with the target object arrives at the first docking position, the first docking device 104a docks with the inlet end of the conveying device 102, and the power transmission mechanism 1042 is flush with the conveying device 102 in height.

Of course, it is also feasible that an end of the first docking device 104a such as the power transmission mechanism 1042 is flush with the conveying device 102 in height. For example, the power transmission mechanism 1042 is set to an inclined state. When the first handling device 106a reaches the first docking position, it docks with the first docking device 104a at the first docking position, and then the target object is transferred from the first handling device 106a to the inclined power transmission mechanism 1042. At this time, the target object will slide along the inclined power transmission mechanism to the conveying device 102 driven by gravity. For some non-fragile items, this setting can save energy and can quickly transfer the target object to the conveying device 102.

In the process where the first handling device 106a loaded with the target object to be transported moves to the first docking device 104a, after the first handling device 106a moves to the first docking position, the first handling device 106a docks with the first docking device 104a at the first docking position, and transfers the target object on the first handling device 106a to the first docking device 104a, and the first docking device 104a then transfers the target object thereon to the conveying device 102. For example, the power transmission mechanism 1042 of the first docking device 104a is started, so that the target object located thereon may be moved to the conveying device 102 along with the power transmission mechanism. The conveying device 102 can transfer the target object to the operation area for a picking body (such as a manual operator or a mechanical arm) to pick out specific goods from the target object. Afterwards, the target object that has been subjected to the picking operation in the operation area may be transferred to the outlet end of the conveying device 102. While the target object is conveyed and picked, the first handling device 106a may go ahead to perform a next task, which may include a task of transporting a target object that has been subjected to the picking operation to the destination, without having to wait for the finish of the picking operation on goods in the target object to be transported, thereby increasing the production capacity of the handling device 106 and improving the operating efficiency.

The above target object conveying system effectively reduces the labor required for picking and handling, and thus saves manpower; at the same time, it reduces the residence time of the handling device 106, makes full use of the production capacity of the handling device 106, and improves the overall warehousing efficiency; also it reduces the direct contact between the operator and the handling device 106, has high safety, and reduces the protection cost of the workstation.

In some examples, there are a plurality of docking manners between the first docking device 104a and the first handling device 106a.

In a process where the first handling device 106a loaded with the target object to be transported moves towards the first docking device 104a, the first handling device 106a raises its top plate 1062 to a second preset height, and transfers the target object from the top plate to the first docking device 104a at the first docking position. The second preset height is determined according to a height of the first docking device 104a.

The second preset height may be understood as a preset height to be raised by the first handling device 106a in the process of docking with the docking device 104. The second preset height may be determined according to the height of the first docking device 104a. For example, if the height of the first docking device 104a is h, then the second preset height may be h, h+a, or h−a, where a is a constant. The first handling device 106a is the handling device 106, and the first docking position may be understood as a docking position at the first docking device 104a.

It may be understood that for the handling device 106, in order to prevent the target object to be transported from falling from the handling device 106, when the handling device 106 transports the target object, the top plate 1062 of the handling device 106 is usually lowered to a lowest position. However, in order to dock with the first docking device 104a, the top plate 1062 need to be raised to make the top plate 1062 basically flush with the first docking device 104a or higher than the first docking device 104a in height, so as to achieve the transfer of the target object.

Based on this, in this docking manner, in a process where the first handling device 106a loaded with the target object to be transported moves towards the first docking device 104a, the first handling device 106a raises its top plate to the second preset height, and the first handling device 106a transfers the target object from the top plate 1062 to the first docking device 104a at the first docking position.

In some embodiments, in this docking manner, the height of the top plate 1062 needs to be adjusted, with detailed implementations as follows.

In a case where it is determined that the second preset height is within a preset height range, the target object on the top plate 1062 is transferred to the first docking device 104a at the first docking position.

The preset height range may be understood as a height range in which the docking between the first docking device 104a and the first handling device 106a is achievable. For example, in a case where the second preset height is h, the preset height range may be (h−a, h+a).

Based on this, in the case where it is determined that the second preset height is within the preset height range, it means that the docking between the first docking device 104a and the first handling device 106a can be achieved, so the target object on the top plate 1062 can be transferred to the first docking device 104a at the first docking position.

However, in a case where it is determined that the second preset height is greater than a maximum height in the preset height range, the top plate 1062 is lowered at the first docking position, and the target object on the top plate 1062 is transferred to the first docking device 104a.

The maximum height in the preset height range may be understood as a maximum height value within the preset height range. For example, for the preset height range (h−a, h+a), the maximum height in the preset height range is h+a.

In the case where the second preset height is greater than the maximum height in the preset height range, it means that the top plate 1062 of the first handling device 106a is raised to such a height that is higher than the height of the first docking device 104a, which means that the docking between the first docking device 104a and the first handling device 106a cannot be achieved at this time. In this case, the top plate 1062 needs to be lowered for docking.

For example, before the first handling device 106a docks with the first docking device 104a, the first handling device 106a may raise the top plate 1062 while moving, which improves the efficiency of cargo transfer, so that after the first handling device 106a reaches the first docking position, there is no need to make further adjustments, which improves the efficiency of cargo transfer.

In an embodiment, the docking manner between the first docking device 104a and the first handling device 106a may also be that the height of the top plate 1062 is adjusted after the first handling device 106a reaches the first docking position, with detailed implementations as follows.

After the handling device 106 loaded with the target object to be transported reaches the first docking position, the top plate 1062 of the first handling device 106a is raised to a second preset height, and the target object on the top plate 1062 is transferred to the first docking device 104a at the first docking position. The second preset height is determined according to the height of the first docking device 104a.

This docking manner does not require the top plate 1062 of the first handling device 106a to be raised in advance. Instead, the top plate 1062 of the first handling device 106a is raised to the second preset height after the first handling device 106a reaches the first docking position. Thereafter, the position and posture of the first handling device 106a may be adjusted to make the docking between the first handling device 106a and the first docking device 104a smoother, so as to transfer the target object on the top plate 1062 to the first docking device 104a.

In some embodiments, in the case where it is determined that the second preset height is within the preset height range, the target object on the top plate 1062 is transferred to the first docking device 104a at the first docking position.

In the case where it is determined that the second preset height is greater than the maximum height in the preset height range, the top plate 1062 is lowered at the first docking position, and the object on the top plate 1062 is transferred to the first docking device 104a.

The process of adjusting the height of the top plate 1062 here is the same as the process of adjusting the height of the top plate 1062 as described in the aforementioned docking manner, which will not be repeated here.

In summary, through this docking manner, the position, posture and height of the first handling device 106a may be adjusted secondary, so as to make the docking between the first handling device 106a and the first docking device 104a smoother, and further achieve the transfer of the target object.

In some examples, after the first handling device 106a reaches the first docking position, the first handling device 106a may lower the height of the top plate 1062 while entering into the gap of the first docking device 104a, so that it can transfer the target object to the first docking device 104a during the movement. With this setting, the first handling device 106a does not need to stay under the first docking device 104a, and can transfer the target object to the first docking device 104a during the movement. Thereafter, the first handling device 106a may go ahead to perform a next task.

It should be noted that the two docking manners between the first docking device 104a and the first handling device 106a at the inlet end of the conveying device 102 are also applicable to the docking between the second docking device 104b and the second handling device 106b at the outlet end of the conveying device 102, which will not be repeated here.

FIG. 4 is a schematic diagram showing a docking path for a handling device and a docking device in a target object conveying system according to an embodiment of the present disclosure. When the first handling device 106a loaded with the target object docks with the first docking device 104a, since the first handling device 106a is in a loaded state, it may move along a first docking path to achieve docking. The second handling device 106b is to transfer the target object after subjected to the picking operation from the second docking device 104b to the second handling device 106b. At this time, the second handling device 106b is in an unloaded state, so when docking with the second docking device 104b, the second handling device 106b in the unloaded state may move along a first unloaded docking path or move along a second unloaded docking path under the conveying device 102.

When moving along the second unloaded docking path, the second handling device 106b may move from either side of the conveying device 102 to below the conveying device 102, and when reaching the position below the second docking device 104b, the second handling device 106b raises the top plate to be flush with the second docking device 104b in height to transfer the target object on the second docking device 104b to the second handling device 106b, and then leaves the second docking device 104b along the second unloaded docking path, and during the movement of the second handling device 106b to leave the second docking device 104b, the first limiting assembly of the second handling device 106b pushes the target object to make the target object move with the second handling device 106b. After leaving the second docking device 104b, the second handling device 106b can lower or adjust the top plate to a height of a rack to be docked, so as to return the target object and ensure the stability of the second handling device during the movement.

For example, before reaching the rack, the second handling device 106b may lower the height of the top plate while moving, so that when the second handling device 106b reaches the rack, the top plate reaches a height of a target storage site on the rack, so that the second handling device 106b directly docks with the target storage site, without need to stay a long time at the rack. In addition, the second handling device 106b does not need to stay at the second docking position for a long time, which not only improves the movement efficiency of the second handling device 106b to the rack, but also vacates the second docking position in time to provide docking space for other second handling devices 106b to dock with the second docking device 104b to timely receive the target objects on the second docking device 104b that have been subjected to picking operation.

In summary, with the target object conveying system according to embodiments of the present disclosure, after the handling device 106 takes out the target object to be transported from the rack, it docks with the conveying device 102 through the docking device 104 to convey the target object to the operation area, at this time, the handling device 106 completes this handling task and may start the next task. After the operator completes the picking operation, the target object that has been subjected to the picking operation is conveyed to the outlet end of the conveying device 102, and taken away by the handling device 106 to put back on the rack. In this way, the manual handling process of the target object is avoided, which saves manpower. In addition, a plurality of handling devices 106 are used to perform box removal from or return back to the rack at the same time, which reduces the waiting time and residence time of the robots and make full use of the production capacity of robots.

Since the conveying direction of the conveying device 102 and the docking device 104 in the target object conveying system according to embodiments of the present disclosure is adjustable, the target object conveying system according to embodiments of the present disclosure is applicable to various scenarios such as order processing scenario, picking scenario, and racking scenario.

Embodiments of the present disclosure provides a target object conveying system, which includes a first handling device 106a, a second handling device 106b, a conveying device 102, a first docking device 104a arranged at an inlet end of the conveying device 102, and a second docking device 104b arranged at an outlet end of the conveying device 102; the first handling device 106a is configured to carry a target object to be transported to a first docking position, and transfer the target object to the first docking device 104a at the first docking position; the first docking device 104a is configured to transfer the target object to the inlet end of the conveying device 102; the conveying device 102 is configured to transfer the target object from the inlet end to an operation area for an operator to pick goods in the target object in the operation area, and transfer the target object passing through the operation area to the outlet end of the conveying device 102; and the second docking device 104b is configured to transfer the target object from the outlet end to the handling device 106.

FIG. 5 is a first schematic diagram showing an application of a target object conveying system in a picking and order processing scenario according to an embodiment of the present disclosure. As shown in FIG. 5, the first handling device 106a takes out a target object to be transported from a rack temporary storage site, and after arriving at a workstation, the first handling device 106a places the target object to the inlet end of the conveying device 102 in the workstation through the first docking device 104a. After the operator in the operation area completes the picking task on goods in the target object, the second handling device 106b that waits at the outlet end of the conveying device 102 in advance takes away the target object that has been subjected to the picking operation through the second docking device 104b, and finally puts the target object back to the storage area. The target object on the conveying device 102 moves, along a direction as shown by the arrow, from the inlet end of the conveying device 102 to the operation area, and then to the outlet end of the conveying device 102.

The operation area may include a plurality of picking sites, and the number of picking sites may be determined as required. Put walls are arranged on both sides of a picking subject, such as an operator, and goods picked by the operator from the target object may be placed in sites of the put wall in sequence. The put wall is provided with a scanner, which is able to recognize a barcode of each kind of goods, and each kind of goods are put into a corresponding order site, and then packaged and shipped out. Embodiments of the present disclosure also provide a target object conveying system, which includes: a first handling device 106a, a second handling device 106b, a conveying device 102, a first docking device 104a arranged at an inlet end of the conveying device 102, and a second docking device 104b arranged at an outlet end of the conveying device 102; the conveying device 102 is configured to transfer target objects to be warehoused from an operation area to the inlet end and outlet end of the conveying device 102; the first docking device 104a is configured to transfer the target object from the inlet end to the first handling device 106a; the second docking device 104b is configured to transfer the target object from the outlet end to the second handling device 106b; and the first handling device 106a and the second handling device 106b are configured to transfer the target objects to a rack area.

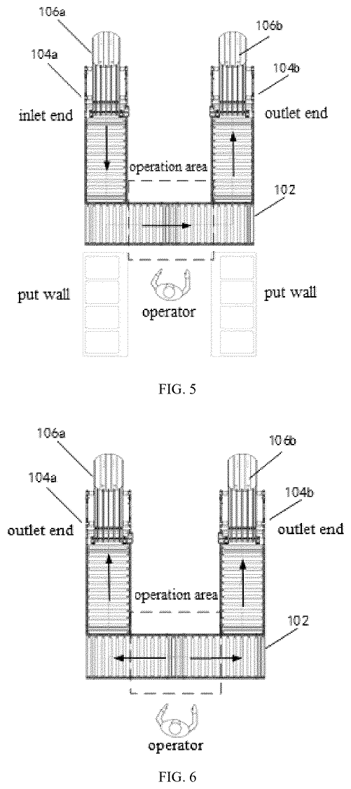

FIG. 6 is a schematic diagram showing an application of a target object conveying system in a racking scenario according to an embodiment of the present disclosure. As shown in FIG. 6, in the racking scenario, the operator places the target objects to be warehoused on the conveying device 102 of the workstation in the operation area. The conveying device 102 may transfer the target objects to the two ends of the conveying device 102 along a direction as shown by the arrow in FIG. 6, and then the target objects are transferred to the first handling device 106a and the second handling device 106b through the first docking device 104a and the second docking device 104b respectively arranged at the two ends of the conveying device 102. The first handling device 106a and the second handling device 106b transport the target objects to the rack for racking and warehousing of the target object.

The operation area may include a plurality of racking sites, and the number of racking sites may be determined as required. In this scenario, both ends of the conveying device 102 are outlet ends. In addition, the number of outlet ends may be set as required. For example, 3 outlet ends, 4 outlet ends, etc., may be set to carry out the racking operation of a plurality of target objects concurrently.

Embodiments of the present disclosure also provides a target object conveying system, which includes: a first handling device 106a, a second handling device 106b, a conveying device 102, a first docking device 104a arranged at an inlet end of the conveying device 102, and a second docking device 104b arranged at an outlet end of the conveying device 102; the first handling device 106a is configured to carry an empty order box and a target object to be picked to a first docking position, and transfer the empty order box and the target object to the first docking device 104a at the first docking position; the first docking device 104a is configured to transfer the empty order box and the target object to the inlet end of the conveying device 102; the conveying device 102 is configured to transfer the empty order box and the target object from the inlet end to an operation area for an operator to pick goods from the target object into the empty order box in the operation area, and transfer the target object after passing through the operation area to the outlet end of the conveying device 102; and the second docking device 104b is configured to transfer the target object from the outlet end to the second handling device 106b.

FIG. 7 is a second schematic diagram showing an application of a target object conveying system in a picking and order processing scenario according to an embodiment of the present disclosure. As shown in FIG. 7, the first handling device 106a transfers the empty order box to the operation area through the first docking device 104a, and the first handling device 106a also transfers the target object to be picked to the operation area through the first docking device 104a. The empty order box and the target object to be picked may be transferred by the same first handling device 106a to the first docking device 104a successively, or may be transported by two first handling devices 106a, with one of which transports the empty order box, and the other one transports the target object to be picked, and the empty order box and the target object to be picked are transferred to the first docking device 104a in sequence, which are then transferred by the first docking device 104a to the operation area. The operator starts the picking operation after obtaining the empty order box and the target object in the operation area, and transfers the order box and the target object after subjected to the picking operation to the second handling device 106b through the second docking device 104b. The target object after subjected to the picking operation may be transported by the second handling device 106b back to the storage area, and the order box after the picking operation may be transported by the second handling device 106b to a next operation area for sorting or packaging.

In summary, the target object conveying system according to embodiments of the present disclosure can achieve concurrent operations by matching human efficiency and setting the number of inlet ends and outlet ends of the conveying device 102, and is applicable to a variety of application scenarios with high versatility.

In addition, the target object conveying system may also be configured with single stations and multi stations as required to achieve concurrent of operations.

In an embodiment of the present disclosure, the target object conveying system may be used in the entire process of a target object warehouse to realize the automation of the handling, picking, and packaging of the target object in the warehouse. Embodiments of the present disclosure also provide a warehouse, which includes a warehousing area, a first storage area for storing a target object, a second storage area for storing a target object to be shipped out, an operation area and a shipping-out area.

The handling device 106 is configured to transfer the target object to be shipped out among target objects in the warehousing area to the second storage area, and transfer remaining target objects in the warehousing area other than the target object to be shipped out to the first storage area, according to a preset storage strategy.

The handling device 106 is configured to transfer the target object to be shipped out from the second storage area to the operation area, the operation area is deployed with at least one target object conveying system according to embodiments of the present disclosure, and the target object conveying system is configured to perform picking of the target object to be shipped out to obtain a picked target object.

The handling device 106 is configured to transfer the picked target object to the shipping-out area.

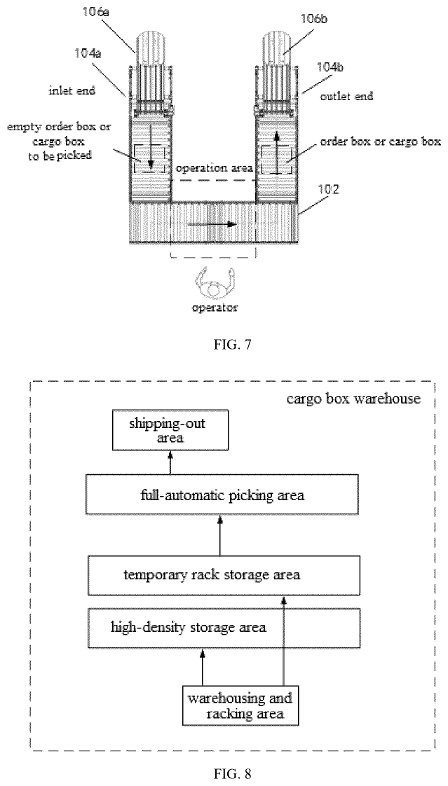

FIG. 8 is a schematic flow chart diagram showing an application of a target object conveying system in a target object warehouse according to embodiments of the present disclosure. Referring to FIG. 8, the entire process of the target object warehouse involves an warehousing and racking area (i.e., the warehousing area), a high-density storage area (i.e., the first storage area for storing a target object), a temporary rack storage area (i.e., the second storage area for storing the target object to be shipped out), a full-automatic picking area (i.e., the operation area), and a shipping-out area (i.e., the shipping-out area). The high-density storage area may be understood as an area for storing target objects, and the storage density of the target objects in the area is relatively high, i.e., there are many target objects stored in this area with a relatively small distance between the target objects, and it mainly functions for long-term storage. The temporary rack storage area stores hotspot goods, which may be understood as goods that are temporarily stored in the target object warehouse and have a high shipping-out frequency. In the entire process of the target object warehouse, the target object conveying system not only participates in the racking operation and the picking operation, but also participates in the shipping-out operation of the order box.

After the target object arrives at the warehousing and racking area, a server dispatches the handling device 106 to take the target object from the warehousing conveying line and store it in the high-density storage area. According to a preset storage strategy, goods with the high shipping-out frequency or a next batch of shipping-out target objects pre-hit are stored in the temporary rack storage area, and other goods are stored in the high-density storage area. The handling devices 106 here just travel in passages among the warehousing and racking area, the high-density storage area and the temporary rack storage area, and are responsible for transporting high-level goods to the rack temporary storage site.

Afterwards, the server dispatches the handling device 106 to transport the target object to be picked from the storage area to the full-automatic picking area, and transport the empty order box from an empty-box temporary storage area to the full-automatic picking area. A plurality of target object conveying systems may be deployed in the full-automatic picking area to carry out the picking operation, racking operation, shipping-out operation, etc. Afterwards, the system dispatches the handling device 106 to transport the order box with the picking operation finished to a shipping-out conveying line to carry out the shipping-out of the order box.

In summary, by setting the docking device 104 at an end of the conveying device 102, the above system enables the target object to be transferred between the conveying device 102 and the handling device 106, and the conveying device 102 may be used to transfer the target object between the conveying device 102 and the operation area. When the docking device 104 and the handling device 106 are docked, the power transmission mechanism 1042 in the comb-tooth structure is docked with the adapted top plate 1062 in the comb-tooth structure to achieve the transfer of the target object. After the handling device 106 places the target object on the docking device 104, it can leave the operation area to perform the next task, without having to stay in the operation area and waiting for the operator to finish the operation, which effectively reduces the waiting time of the handling device 106, avoids wasting the production capacity of the handling device 106, improves the working efficiency of the handling device 106, and reduces the contact between the operator and the handling device 106 with high safety.

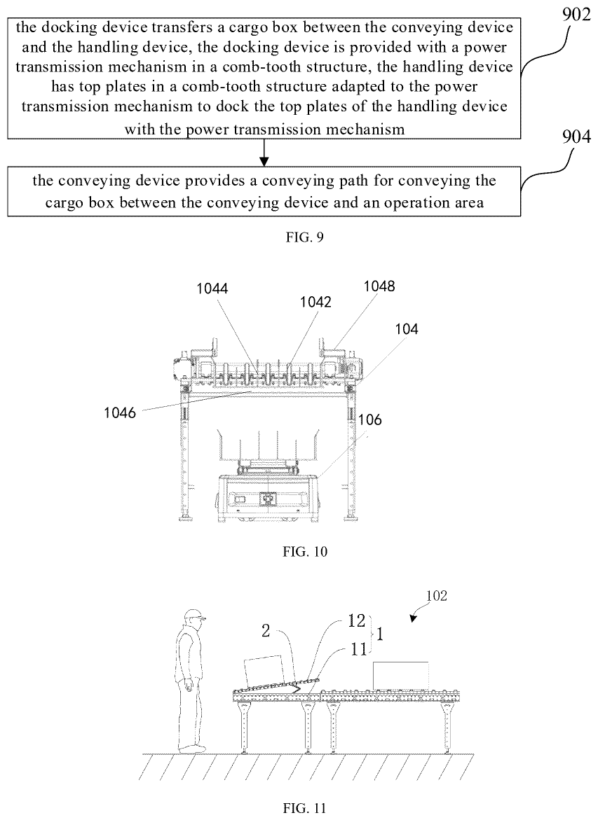

Embodiments of the present disclosure also provide a target object conveying method. FIG. 9 is a schematic flow chart diagram of a target object conveying method according to an embodiment of the present disclosure. The target object conveying method may be applied to the above target object conveying system. The target object conveying system includes a handling device, a conveying device and a docking device arranged at an end of the conveying device. The target object conveying method includes the following steps.

In step 902, the docking device transfers a target object between the conveying device and the handling device, the docking device is provided with a power transmission mechanism in a comb-tooth structure, and the handling device has a top plate in a comb-tooth structure adapted to the power transmission mechanism to dock the top plate of the handling device with the power transmission mechanism.

In step 904, the conveying device provides a conveying path for conveying the target object between the conveying device and an operation area.

In some embodiments, transferring, by the docking device, the target object between the conveying device and the handling device includes that after the handling device reaches a docking position, the top plate is inserted into the power transmission mechanism at the docking position to transfer the target object between the top plate and the power transmission mechanism.

In some embodiments, transferring, by the docking device, the target object between the conveying device and the handling device includes that in a case of transferring the target object from the handling device to the docking device, after the handling device reaches a docking position, the top plate is inserted into the power transmission mechanism at the docking position, and the top plate is lowered by a first preset height to transfer the target object from the top plate to the power transmission mechanism.

In some embodiments, transferring, by the docking device, the target object between the conveying device and the handling device includes that in a case of transferring the target object from the docking device to the handling device, after the handling device reaches a docking position, the top plate is inserted into the power transmission mechanism at the docking position, and the top plate is raised by a first preset height to transfer the target object from the power transmission mechanism to the top plate.

In some embodiments, the docking device includes a first docking device and a second docking device, the first docking device is arranged at an inlet end of the conveying device, and the second docking device is arranged at an outlet end of the conveying device.

Correspondingly, transferring, by the docking device, the target object between the conveying device and the handling device includes that after a first handling device loaded with the target object to be transported reaches a first docking position, the first docking device docks with the inlet end of the conveying device, and the power transmission mechanism is flush with the conveying device in height.

In some embodiments, transferring, by the docking device, the target object between the conveying device and the handling device includes that: in a process where the first handling device loaded with the target object to be transported moves towards the first docking device, the first handling device raises its top plate to a second preset height, and transfers the target object from the top plate to the first docking device at the first docking position, and the second preset height is determined according to a height of the first docking device.

In some embodiments, transferring the target object to be transported from the top plate to the first docking device at the first docking position includes that in a case where it is determined that the second preset height is within a preset height range, the target object to be transported is transferred from the top plate to the first docking device at the first docking position.

In some embodiments, transferring the target object to be transported from the top plate to the first docking device at the first docking position includes that in a case where it is determined that the second preset height is greater than a maximum height in a preset height range, the top plate is lowered at the first docking position to transfer the target object from the top plate to the first docking device.

In some embodiments, transferring, by the docking device, the target object between the conveying device and the handling device includes that after the first handling device loaded with the target object to be transported reaches the first docking position, the first handling device raises its top plate to a second preset height, and transfers the target object from the top plate to the first docking device at the first docking position, and the second preset height is determined according to a height of the first docking device.

In some embodiments, transferring the target object to be transported from the top plate to the first docking device at the first docking position includes that in a case where it is determined that the second preset height is within a preset height range, the target object to be transported is transferred from the top plate to the first docking device at the first docking position.

In some embodiments, transferring the target object to be transported from the top plate to the first docking device at the first docking position includes that in a case where it is determined that the second preset height is greater than a maximum height in a preset height range, the top plate is lowered at the first docking position to transfer the target object from the top plate to the first docking device.

In summary, by setting the docking device at an end of the conveying device, the above method enables the target object to be transferred between the conveying device and the handling device, and the conveying device may be used to transfer the target object between the conveying device and the operation area. When the docking device and the handling device are docked, the power transmission mechanism in the comb-tooth structure may be docked with the adapted top plate 1062 in the comb-tooth structure to achieve the transfer of the target object. After the handling device places the target object on the docking device, it can leave the operation area to perform the next task, without having to stay in the operation area and waiting for the operator to finish the operation, which effectively reduces the waiting time of the handling device, avoids wasting the production capacity of the handling device, improves the working efficiency of the handling device, and reduces the contact between the operator and the handling device with high safety.

It should be noted that the technical solution of the target object conveying method has the same concept as the technical solution of the above target object conveying system, and for details not described with respect to the technical solution of the target object conveying method, reference may be made to the description of the technical solution of the above-mentioned target object conveying system.

Embodiments of the present disclosure further provide a docking device, which may be used in a target object conveying system, i.e., may be used between a conveying device and a handling device. FIG. 10 is a schematic diagram of a docking device according to embodiments of the present disclosure. Referring to FIG. 10, the docking device 104 includes a base 1046, a power transmission mechanism 1042 disposed on the base 1046, and a power supply mechanism 1044 disposed on the base 1046.

The power supply mechanism 1044 is configured to provide power to the power transmission mechanism 1042 to move the power transmission mechanism 1042.

The power transmission mechanism 1042 is configured to bear the target object to be transported and move the target object along with the power transmission mechanism 1042.

The power transmission mechanism 1042 is provided with a second limiting assembly 1048, and the second limiting assembly 1048 is configured to limit a transfer path of the target object at the power transmission mechanism.

The power transmission mechanism 1042 may be, for example, a conveyor belt, a conveyor chain, etc., and the target object to be transported may be placed on the conveyor belt and move along with the conveyor belt. The power supply mechanism 1044 may be, for example, a motor. When the docking device 104 and the handling device are docked, the handling device is located below the docking device 104.

In order to enable the docking device 104 and the handling device 106 to dock better, the power transmission mechanism 1042 is in the comb-tooth structure, so that during docking, since the top plate 1062 of the handling device 106 is also in the comb-tooth structure, the top plate 1062 of the handling device 106 may be inserted into the gaps of the power transmission mechanism 1042 to achieve docking.

When the transfer direction of the target object to be transported needs to be changed as required, the rotation direction of the power supply mechanism 1044 may be adjusted to change the transfer direction of the target object at the power transmission mechanism 1042.

The power supply mechanism 1044 may be, for example, a motor. Changing the rotation direction of the motor will change the transmission direction of the power transmission mechanism 1042. Based on this, the inlet end may be switched into the outlet end, and vice versa, which further ensures the setting of a plurality of inlet ends and outlet ends as required.

To sum up, with the above docking device 104, the handling device 106 may place the loaded target object on the docking device 104, and the docking device 104 transfers the target object to the conveying device 102 to further reach the operation area. After the handling device 106 places the target object on the docking device 104, it can leave the operation area to perform the next task, without having to stay in the operation area and waiting for the operator to finish the operation, which effectively reduces the waiting time of the handling device 106, avoids wasting the production capacity of the handling device 106, improves the working efficiency of the handling device 106, and reduces the contact between the operator and the handling device 106 with high safety.

The above conveying device is able to transfer the target object from the inlet end to the operation area for an operator to pick goods in the target object in the operation area. After the picking operation is finished, the conveying device transfers the target object after subjected to the picking operation to the outlet end. However, in the picking operation, the operators have to repeatedly lower their heads and bend down, which result in low picking efficiency and high labor intensity and make the operators easy to get tired.

In view of above, embodiments of the present disclosure further provide a conveying device. FIG. 11 is a schematic diagram showing an overall structure of a conveying device according to embodiments of the present disclosure. As shown in FIG. 11, the conveying device 102 may include a bearing device 1 and an adjusting device 2, and the bearing device 1 includes a body 11 and a bearing part 12 disposed on the body 11. The bearing part 12 is configured to bear a target object for subjecting to a picking operation at the bearing part. The adjusting device 2 is configured to adjust the bearing part 12 or the target object on the bearing part 12 to an inclined state.

When an operator, such as a picker, performs a picking operation on the target object on the bearing part 12, in the inclined state, the end of the bearing part 12 or the target object closer to the picker is lower, and the other end farther away from the picker is higher.

The adjustment purpose of the adjusting device 2 is to tilt the target object. The adjusting device 2 may adjust the bearing part 12 to tilt the target object on the bearing part 12, or directly adjust the target object without acting on the bearing part 12. When the target object is in the inclined state, it is more convenient for the pickers to perform the picking operation, without repeatedly lowering their heads and bending over, which reduces the labor intensity of the pickers and is conducive to improving the picking efficiency.

The bearing part 12 may bear the target object in a horizontal posture, and the adjusting device 2 may adjust the bearing part 12 or the target object by raising or lowering an end of the bearing part 12 or the target object or by driving the bearing part 12 or the target object to rotate. At least one bearing part 12 may be disposed on the body 11 of the bearing device 1, and the adjusting device 2 is used to adjust an inclination angle of the at least one bearing part 12 or the target object on the at least one bearing part 12.

In an embodiment, the bearing device 1 is a conveying line arranged at a picking station (i.e., the operation area).

In an embodiment, the adjusting device 2 is disposed on the bearing device 1. For example, the adjusting device 2 may be disposed on the body 11, or disposed on the bearing part 12. The adjusting device 2 is configured to cooperate with the target object on the bearing part 12, and drive the target object to an inclined state. For example, the adjusting device 2 may be a push rod disposed on the body 11, and the push rod is able to pass through the bearing part 12 upward under a driving action, and lift an end of the target object on the bearing part 12 to tilt the target.

In an embodiment of the present disclosure, as shown in FIG. 11, the adjusting device 2 is disposed between the body 11 and the bearing part 12, and is configured to drive the bearing part 12 to an inclined state.

To prevent the target object from slipping when the bearing part 12 is inclined, a baffle may be provided on the bearing part 12 to block the target object, or a sufficient friction force may be maintained between the bearing part 12 and the target object. The inclination angle of the bearing part 12 should be limited to a suitable range to prevent the target object from falling down.

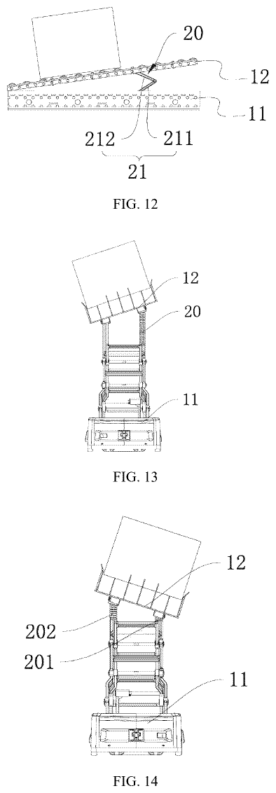

FIG. 12 is a schematic diagram of a bearing device and a connecting rod mechanism according to embodiments of the present disclosure. Referring to FIG. 11 and FIG. 12, in some embodiments, the adjusting device 2 may be a lifting mechanism 20, an end of the bearing part 12 is movably connected to the body 11, and the opposite end may be raised or lowered under the driving action of the lifting mechanism 20 to make the target object inclined. In the embodiments shown in FIG. 11 and FIG. 12, the bearing device 1 is a conveying line, and the bearing part 12 is able to convey the target object. In an initial state, the bearing part 12 bears the target object in a horizontal posture, and the lifting mechanism 20 is able to drive the end of the bearing part 12 farther away from the operator to be raised, or drive the end of the bearing part 12 closer to the operator to be lowered. After the picking operation, the lifting mechanism 20 is able to drive the inclined bearing part 12 back to the initial state.

In an embodiment of the present disclosure, as shown in FIG. 12, the lifting mechanism 20 includes a connecting rod mechanism 21 and a driver. The connecting rod mechanism 21 may include a first connecting rod 211 and a second connecting rod 212 that are movably connected, and an end of the first connecting rod 211 is movably connected to an end of the second connecting rod 212. An outer end of the first connecting rod 211 is movably connected to the body 11, and an outer end of the second connecting rod is movably connected to the bearing part 12. For example, the body 11 may be provided with a track thereon, and the first connecting rod 211 is able to slide along the track on the body 11; and the bearing part 12 may be provided with a track thereon, and the second connecting rod 212 is able to slide along the track on the bearing part 12. The driver is configured to provide power and is able to drive the connecting rod mechanism 21 to slide along the slide rail. The driver drives the connecting rod mechanism 21 to move away from or close to the operator to adjust the bearing part 12 to rise or fall at the end connecting the body 11, so as to change the inclination degree of the target object.

The driver may be connected between the first connecting rod 211 and the second connecting rod 212, and is configured to drive the first connecting rod 211 and the second connecting rod 212 to rotate relative to each other, i.e., to change an angle between the first connecting rod 211 and the second connecting rod 212, thereby driving the bearing part 12 to rotate relative to the body 11, to raise or lower the end of the bearing part 12 that is not connected to the body 11. The driver may be a telescopic driver that provides a linear driving force, such as an electric drive pusher, a hydraulic cylinder, a pneumatic cylinder, or the like, with an end movably connected to the first connecting rod 211, and the other end movably connected to the second connecting rod 212.

In some embodiments of the present disclosure, FIG. 13 is a schematic diagram of a bearing device and a lifting mechanism according to embodiments of the present disclosure; as shown in FIG. 13, the lifting mechanism 20 includes a telescopic driver, and the telescopic driver may be a power device that provides a linear driving force, such as an electric drive pusher, a hydraulic cylinder, a pneumatic cylinder, or the like. In the embodiment shown in FIG. 13, the bearing device 1 is a mobile robot for transporting the target object. An end of the telescopic driver is connected to the body 11, and the other end is connected to the bearing part 12. The telescopic driver is able to drive the end of the bearing part 12 that is connected to the body 11 to rise when its output end is extended, and drive the bearing part 12 to fall back to its initial position when its output end is retracted.

In some embodiments, FIG. 14 is a schematic diagram of a bearing device, a first lifting mechanism, and a second lifting mechanism according to embodiments of the present disclosure; as shown in FIG. 14, the adjusting device 2 includes a first lifting mechanism 201 and a second lifting mechanism 202 that are arranged at intervals between the body 11 and the bearing part 12. The bearing part 12 is disposed on the body 11 through the first lifting mechanism 201 and the second lifting mechanism 202, and the first lifting mechanism 201 and the second lifting mechanism 202 are connected to the opposite ends of the bearing part 12, respectively. The first lifting mechanism 201 and the second lifting mechanism 202 work independently of each other, and are configured to drive the bearing part 12 to move up and down, and is able to drive the opposite ends of the bearing part 12 to move to different heights to tilt the bearing part 12.

In detail, each of the first lifting mechanism 201 and the second lifting mechanism 202 may be a power device that provides a linear driving force, such as an electric drive pusher, a hydraulic cylinder, a pneumatic cylinder, or the like. The top ends of the first lifting mechanism 201 and the second lifting mechanism 202 are connected to the bearing part 12, and their bottom ends are connected to the body 11. The first lifting mechanism 201 and the second lifting mechanism 202 are at least movably connected to the body 11 or the bearing part 12, providing movement allowance in the horizontal direction.

The first lifting mechanism 201 and the second lifting mechanism 202 can not only tilt the bearing part 12 in different directions, but also adjust the height of the bearing part 12, so as to adjust the target object to a height suitable for the height of the operator.

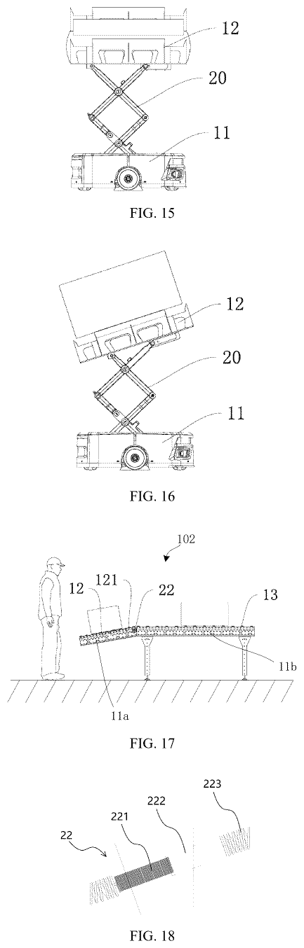

In an embodiment of the present disclosure, FIG. 15 is a schematic diagram of a bearing device and a scissor-type lifting mechanism according to embodiments of the present disclosure; FIG. 16 is another schematic diagram of a bearing device and a scissor-type lifting mechanism according to embodiments of the present disclosure; as shown in FIG. 15 and FIG. 16, the lifting mechanism 20 may be a scissor-type lifting mechanism, including at least two cross-connected connecting rods, and the driver drives the at least two connecting rods to rotate relative to each other to raise or lower the bearing part 12. One of the at least two connecting rods may be set as a telescopic structure, such as an electric telescopic rod, which is able to tilt the bearing part 12 through the telescopic movement.

In an embodiment, FIG. 17 is a schematic diagram of a bearing device and an angle adjustment mechanism according to embodiments of the present disclosure; as shown in FIG. 17, the bearing device 1 may be a conveyor, such as a roller conveyor, a belt conveyor, etc. The bearing part 12 of the bearing device 1 may include a conveying mechanism 121 for conveying a target object, such as a roller, a transmission belt, etc.

In detail, the bearing device 1 may further include a fixed conveying part 13, which is able to transport the target object to the bearing part 12, or take the target object from the bearing part 12. The fixed conveying unit 13 may be a conveying structure such as a roller or a conveyor belt. It may be understood that the fixed conveying unit 13 may be a conveying structure in other areas of the bearing device 1 except the operation area.

As shown in FIG. 17, the bearing part 12 and the fixed conveying part 13 may be movably connected, and the adjusting device 2 is able to drive the bearing part 12 to rotate relative to the fixed conveying part 13 to an inclined state.

In an example, as shown in FIG. 17, the bearing device 1 includes a first part and a second part connected in sequence along the conveying direction, wherein the first part is a structure in the operation area, and the second part is other structure located outside the operation area. The first part includes the bearing part 12 and a body (e.g., a first body 11a), and they may be fixedly connected; the second part includes the fixed conveying part 13 and a body (e.g., a second body 11b), and they may be fixedly connected.

The first part and the second part may be rotatably connected. In some examples, the two ends of the angle adjustment mechanism 22 may be connected to the first body and the second body, respectively, so that the bearing part 12 may be rotated relative to the fixed conveying part 13 to an inclined state. In other examples, the two ends of the angle adjustment mechanism 22 may be connected to the bearing part and the second body 11b, respectively.

For example, an end of the bearing part 12 is rotatably connected to the second part, such as to the second body 11b, and the adjusting device 2 includes an angle adjusting mechanism 22 for adjusting a relative angle between the bearing part 12 and the second body 11b. In the embodiment shown in FIG. 17, the bearing device 1 is a conveying line. The angle adjusting mechanism 22 may be provided with a knob to adjust the angle manually; or the angle adjusting mechanism 22 may be provided with a driver to adjust the angle automatically.

FIG. 18 is a schematic diagram of a screw-sleeve assembly according to embodiments of the present disclosure; as shown in FIG. 18, the angle adjustment mechanism 22 includes a screw-sleeve assembly movably connected between the bearing part 12 and the second body 11b, the screw-sleeve assembly includes a screw 221 and a sleeve 222 that are in threaded connection, one of the screw 221 and the sleeve 222 is movably connected to the second body 11b, and the other is movably connected to the bearing part 12. A spring 223 is provided at an end of the screw 221 and/or the sleeve 222, and the spring 223 is able to provide movement allowance for the screw-sleeve assembly when the bearing part 12 and the second body 11b rotate relative to each other. The screw-sleeve assembly will be extended or shortened when the screw 221 and the sleeve 222 rotate relative to each other, and the screw-sleeve assembly is configured to extend or shorten when rotating to drive the bearing part 12 and the second body 11b to rotate relative to each other.

Further, the angle adjustment mechanism 22 further includes a knob assembly in transmission fit with the screw-sleeve assembly, and the knob assembly is configured to rotate under an external force to drive the screw-sleeve assembly to rotate. The operator may manually rotate the knob assembly to adjust the relative angle between the bearing part 12 and the second body 11b.

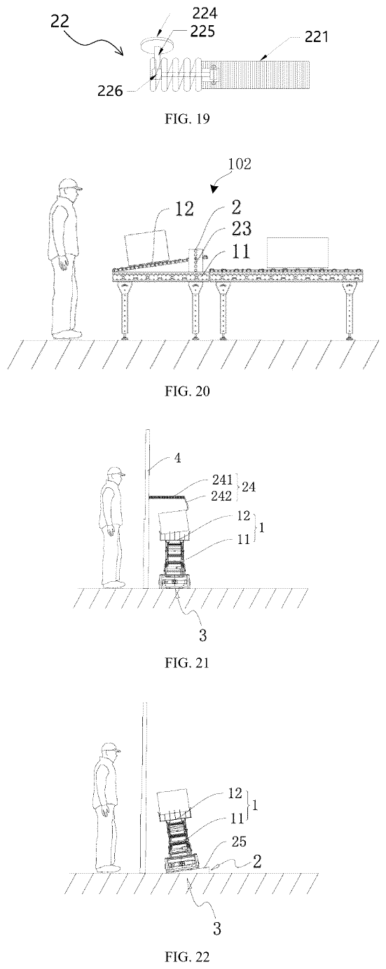

FIG. 19 is a schematic diagram of a knob assembly according to embodiments of the present disclosure; as shown in FIG. 19, the knob assembly includes a knob 224 and a transmission rod 225 that are fixedly connected, and the transmission rod 225 may be fit with the screw 221 or the sleeve 222 through a worm gear structure 226, and the worm gear structure 226 is used to change a torque direction, so that the knob 224 may be installed on a side of the second body 11b or the bearing part 12, which is convenient for manual operation of the operator. When the knob 224 is turned, the screw 221 or the sleeve 222 is driven to rotate through the worm gear structure 225, so as to adjust the relative angle between the bearing part 12 and the second body 11b.

The structure and principle of the above angle adjustment mechanism 22 are used as examples, and other types of angle adjustment mechanisms 22 that are implementable by those skilled in the art may also be adopted.

In an embodiment, FIG. 20 is a schematic diagram of a bearing device and an adjusting device with a connecting part according to embodiments of the present disclosure, as shown in FIG. 20, the bearing part 12 and the fixed conveying part 13 may not be connected, the bearing part 12 in a horizontal state is flush with the fixed conveying part 13, and the adjusting device 2 may raise an end of the bearing part 12 to tilt the bearing part 12. The adjusting device 2 includes a bracket disposed on the body 11, and the bracket is provided with at least two connecting parts 23 distributed in a height direction, and the connecting parts 23 are configured to connect with the bearing part 12. An end of the bearing part 12 is disposed on the body 11, and the other end is detachably connected to any of the connecting parts 23, so that the two ends of the bearing part 12 are different in height, and the bearing part 12 is in an inclined state. The connecting part 23 includes but is not limited to a jack, a groove, a buckle, a lug plate, or the like.

In an embodiment shown in FIG. 20, the adjusting device 2 is fixed on the body 11 and close to an end of the bearing part 12, the connecting parts 23 may be mounting holes at the adjusting device 2, and the mounting holes are arranged in the height direction. An end of the bearing part 12 is supported on the body 11, and the other end may be fixed to a mounting hole at any height by a screw, a rod, etc., so that the bearing part 12 may be adjusted to different inclination angles.

In an embodiment, the target object conveying system includes a control system, which is able to control the adjusting device 2 to work according to an instruction, and control the adjusting device 2 to adjust the bearing part 12 or the target object to a predetermined angle. The control system is able to receive data information such as the height and arm length of the picker, and control the adjusting device 2 to adjust the bearing part 12 or the target object to a suitable inclination angle according to the data information of the picker. The picker may also autonomously adjust the inclination angle of the bearing part 12 or the target object through the control system.

In an embodiment, the conveying device includes a bearing device 1 and an adjusting device 2, the bearing device 1 includes a body 11 and a bearing part 12 disposed on the body 11. The bearing part 12 is configured to bear a target object for subjecting to a picking operation at the bearing part 12. The adjusting device 2 is configured to adjust the bearing part 12 or the target object on the bearing part 12 to an inclined state.

The adjusting device 2 tilts the target object by adjusting the bearing part 12, or directly adjusts the target object to an inclined state. When the operator performs a picking operation on the target object on the bearing part 12, in the inclined state, the end of the bearing part 12 or the target object closer to the operator is lower, and the other end farther away from the operator is higher, so it is more convenient for the operator to perform the picking operation, without repeatedly lowering the head and bending over, which reduces the labor intensity of the picker and is conducive to improving the picking efficiency.

The bearing part 12 may bear the target object in a horizontal posture, and the adjusting device 2 may adjust the bearing part 12 or the target object by raising or lowering an end of the bearing part 12 or the target object or by driving the bearing part 12 or the target object to rotate. At least one bearing part 12 may be disposed on the body 11 of the bearing device 1, and the adjusting device 2 is used to adjust an inclination angle of the at least one bearing part 12 or the target object on the at least one bearing part 12.

In an embodiment, FIG. 21 is a schematic diagram showing an overall structure of a target object conveying system according to embodiments of the present disclosure; as shown in FIG. 21, the bearing device 1 is a mobile robot, a travelling mechanism for travelling is disposed on the body 11, and the mobile robot is able to transport the target object from the warehouse, the rack or other location to the workstation. The picker performs the picking operation at a picking site 3 of the workstation, and the adjusting device 2 may be provided in the operation area 3. When the target object reaches the operation area 3 with the bearing device 1, the adjusting device 2 is configured to be able to move to fit with the bearing part 12 or the target object on the bearing part 12, and drive an end of the bearing part 12 or the target object to move up and down to tilt the bearing part 12 or the target object.

In an embodiment, the adjusting device 2 includes a mechanical claw 24, which is configured to fit with an end of the bearing part 12 or the target object and raise or lower the end of the bearing part 12 or the target object. The mechanical claw 24 may fit with the bearing part 12 or the target object by means of buckling, magnetic attraction, push-pull, clamping, etc.

In an embodiment, a certain safety distance is left between the operator and the operation area 3, and a safety door 4 may be set between the operator and the operation area 3 to protect the picker. When the safety door 4 is opened, the picker may perform the picking operation on the target object on the bearing device 1. The adjusting device 2 may be set on the safety door 4.

In an embodiment, the mechanical claw 24 includes a mechanical arm 241 disposed on the safety door 4 and a claw 242 disposed at the end of the mechanical arm 241. The mechanical arm 241 extends towards the operation area 3 to above the bearing device 1. The claw 242 is able to rotate downwards and fit with the end of the target object away from the operator, and then the mechanical arm 241 is lifted upwards to tilt the target object.

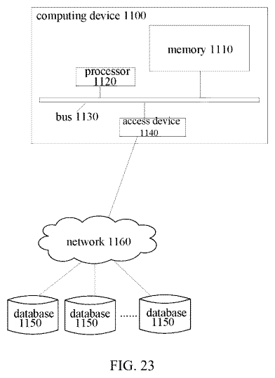

In an embodiment, FIG. 22 is a schematic diagram showing an overall structure of a target object conveying system according to embodiments of the present disclosure; as shown in FIG. 22, the bearing device 1 includes a body 11 and a bearing part 12 disposed on the body 11. The bearing part 12 is configured to bear a target object for subjecting to a picking operation at the bearing part.

The adjusting device 2 includes a supporting part 25 for supporting the bearing device 1, and the supporting part 25 is configured to be movable to an inclined state to adjust the bearing part 12 of the bearing device 1 or the target object on the bearing part 12 to an inclined state.

The bearing device 1 may be a mobile robot. In embodiments of the present disclosure, the structure and principle of the bearing device 1 may refer to the bearing device 1 in the above embodiments, and will not be described in detail in embodiments of the present disclosure.

In an embodiment of the present disclosure, as shown in FIG. 22, the adjusting device 2 may be disposed on the ground of the operation area 3 of the workstation, and the bearing device 1 is able to travel to the supporting part 25. The supporting part 25 may be a supporting plate flush with the ground of the operation area, and the adjusting device 2 is able to raise an end of the supporting plate to tilt the supporting plate. The adjusting device 2 may be disposed at the bottom of the supporting part 25, and includes a driver to provide power, like an electric drive pusher, a pneumatic cylinder, a hydraulic cylinder, etc.

When the bearing device 1 travels onto the supporting part 25 of the adjusting device 2, the supporting part 25 is configured to move to an inclined state to tilt the bearing device 1, and the target object on the bearing device 1 also tilts accordingly. It is more convenient for the operator to perform the picking operation, without repeatedly lowering the head and bending over, which reduces the labor intensity of the picker and is conducive to improving the picking efficiency.

FIG. 23 is a schematic block diagram of a computing device 1100 according to embodiments of the present disclosure. The components of the computing device 1100 include but are not limited to a memory 1110 and a processor 1120. The processor 1120 is connected to the memory 1110 via a bus 1130, and a database 1150 is configured to store data.

The computing device 1100 also includes an access device 1140 that enables the computing device 1100 to communicate via one or more networks 1160. Examples of these networks include a public switched telephone network (PSTN), a local area network (LAN), a wide area network (WAN), a personal area network (PAN), or a combination of communication networks like the Internet. The access device 1140 may include one or more of any types of network interfaces (e.g., network interface card (NIC)), either wired or wireless, such as an IEEE 802.11 wireless local area network (WLAN) wireless interface, a worldwide interoperability for microwave access (Wi-MAX) interface, an Ethernet interface, a universal serial bus (USB) interface, a cellular network interface, a Bluetooth interface, a near field communication (NFC) interface, or the like.

In an embodiment of the present disclosure, the above components of the computing device 1100 and other components not shown in FIG. 23 may also be connected to each other, for example, via a bus. It should be understood that the block diagram of the computing device as shown in FIG. 23 is used as an example and is not intended to limit the scope of the present disclosure. Those skilled in the art may add or replace with other components as needed.

The computing device 1100 may be any type of stationary or mobile computing device, including a mobile computer or a mobile computing device (e.g., a tablet computer, a personal digital assistant, a laptop computer, a notebook computer, a netbook, etc.), a mobile phone (e.g., a smart phone), a wearable computing device (e.g., a smart watch, a smart glasses, etc.), or other types of mobile devices, or a stationary computing device such as a desktop computer or a personal computer (PC). The computing device 1100 may also be a mobile or stationary server.

The processor 1120 is configured to execute the following computer executable instructions that, when executed by the processor, cause the steps of the above target object conveying method to be implemented.

The above are example solutions of the computing device according to embodiments of the present disclosure. It should be noted that the technical solutions of the computing device have the same concept as the technical solutions of the above target object conveying method, and for details not described in the technical solutions of the computing device, reference may be made to the description of the technical solutions of the above target object conveying method.

An embodiment of the present disclosure provides a computer-readable storage medium having stored therein computer-executable instructions that, when executed by a processor, cause the steps of the above target object conveying method to be implemented.

The above is an example solution of the computer-readable storage medium according to embodiments of the present disclosure. It should be noted that the technical solution of the storage medium has the same concept as the technical solutions of the above target object conveying method, and for details not described in the technical solution of the storage medium, reference may be made to the description of the technical solutions of the above target object conveying method.

An embodiment of the present disclosure provides a computer program that, when executed in a computer, causes the computer to execute the steps of the above target object conveying method.

The above is an example solution of the computer program according to embodiments of the present disclosure. It should be noted that the technical solution of the computer program has the same concept as the technical solutions of the above target object conveying method, and for details not described in the technical solution of the computer program, reference may be made to the description of the technical solutions of the above target object conveying method.

The above describes specific embodiments of the present disclosure. Other embodiments are within the scope of the appended claims. In some cases, the actions or steps described in the claims may be performed in an order different from that described in the embodiments and can still achieve the desired results. In addition, the process depicted in the accompanying drawings does not necessarily require the specific order or continuous order as shown to achieve the desired results. In some embodiments, multitasking and parallel processing are also possible or may be advantageous.

Computer instructions include computer program codes, which may be in source code form, object code form, executable files or some intermediate form, etc. Computer readable media may include: any entity or device capable of carrying computer program codes, recording media, USB flash drive, mobile hard disk, magnetic disk, optical disk, computer memory, read-only memory (ROM), random access memory (RAM), electric carrier signals, telecommunication signals, and software distribution media, etc. It should be noted that the contents include in the computer readable media may be appropriately increased or decreased according to the requirements of legislation and patent practice in a jurisdiction. For example, in some jurisdictions, according to legislation and patent practice, the computer readable media do not include electric carrier signals and telecommunication signals.

It should be noted that, for the above various method embodiments, for the sake of simplicity of description, they are expressed as combinations of a series of action, but those skilled in the art should be aware that the embodiments of the present disclosure are not limited by the described action sequence, because according to the embodiments of the present disclosure, certain steps may be performed in other sequences or may be performed concurrently. In addition, those skilled in the art should also be aware that the embodiments described in the specification are example embodiments, and the involved actions and modules are not necessarily required by the embodiments of the present disclosure.

In the above embodiments, the description of each embodiment has its own emphasis. For parts that are not described in detail in a certain embodiment, reference may be made to the relevant descriptions of other embodiments.

The example embodiments of the present disclosure as disclosed above are used to help explain this specification. The optional embodiments do not elaborate all the details, nor do they limit present disclosure to the specific embodiments as described. Apparently, many modifications and changes may be made according to the content of the embodiments in this specification. These embodiments selected and described in detail in this specification are to better explain the principles and practical applications of the embodiments of this specification, to make those skilled in the art to better understand and use this specification. This specification is only limited by the claims and their whole scope and equivalents.

1. A target object conveying system, comprising:
a handling device,
a conveying device, and
a docking device, arranged at an end of the conveying device and configured to transfer a target object between the conveying device and the handling device,
wherein the docking device is provided with a power transmission mechanism in a comb-tooth structure;
the handling device is provided with a top plate in a comb-tooth structure adapted to the power transmission mechanism, and the comb-tooth structures are configured to dock the top plate of the handling device with the power transmission mechanism; and
the conveying device is configured to provide a conveying path for conveying the target object between the conveying device and an operation area.

2. The system according to claim 1, wherein the handling device is configured to: insert the top plate into the power transmission mechanism at a docking position to transfer the target object between the top plate and the power transmission mechanism.

3. The system according to claim 1, wherein the handling device is configured to:
insert the top plate into the power transmission mechanism at a docking position, and lower the top plate by a first preset height to transfer the target object from the top plate to the power transmission mechanism; or
insert the top plate into the power transmission mechanism at a docking position, and raise the top plate by a first preset height to transfer the target object from the power transmission mechanism to the top plate.

1. (canceled)

13. The system according to claim 1, wherein the conveying device comprises:
a bearing device, comprising: a body, and a bearing part disposed on the body and configured to bear the target object for subjecting to a picking operation at the bearing part; and
an adjusting device, configured to adjust the bearing part or the target object on the bearing part to an inclined state.

14. (canceled)

15. The system according to claim 13, wherein the adjusting device is disposed between the body and the bearing part, and is configured to drive the bearing part to the inclined state.

16. The system according to claim 15, wherein the adjusting device comprises a lifting mechanism, an end of the bearing part is movably connected to the body, and the other end of the bearing part is lifted or lowered under a driving action of the lifting mechanism.

17. The system according to claim 16, wherein the lifting mechanism comprises a connecting rod mechanism and a driver, the connecting rod mechanism comprises a first connecting rod and a second connecting rod that are movably connected, an outer end of the first connecting rod is movably connected to the body, an outer end of the second connecting rod is movably connected to the bearing part; and the driver is configured to drive the first connecting rod and the second connecting rod to rotate relative to each other.

18. The system according to claim 13, wherein an end of the bearing part is rotatably connected to the body, the adjusting device comprises an angle adjusting mechanism for adjusting a relative angle between the bearing part and the body, the angle adjusting mechanism comprises a screw-sleeve assembly movably connected between the bearing part and the body, the screw-sleeve assembly is configured to extend or shorten when rotating to drive the bearing part and the body to rotate relative to each other, the angle adjusting mechanism further comprises a knob assembly in transmission fit with the screw-sleeve assembly, and the knob assembly is configured to rotate under an external force to drive the screw-sleeve assembly to rotate.

19. The system according to claim 13, wherein the adjusting device comprises a bracket disposed on the body, the bracket is provided with at least two connecting parts distributed in a height direction, an end of the bearing part is disposed on the body, and the other end of the bearing part is connected to any of the connecting parts of the adjusting device.

20.-21. (canceled)

22. The system according to claim 1, wherein the handling device comprises a first handling device and a second handling device, the docking device comprises a first docking device arranged at an inlet end of the conveying device, and a second docking device arranged at an outlet end of the conveying device;
wherein the first handling device is configured to carry a target object to be transported to a first docking position and transfer the target object to be transported to the first docking device at the first docking position;
the first docking device is configured to transfer the target object to be transported to the inlet end of the conveying device;
the conveying device is configured to transfer the target object to be transported from the inlet end to an operation area for an picking operation of the target object in the operation area, and transfer the target object passing through the operation area to the outlet end of the conveying device; and
the second docking device is configured to transfer the target object from the outlet end to the second handling device.

23.-27. (canceled)

28. The system according to claim 1, wherein the handling device comprises a first handling device and a second handling device, the docking device comprises a first docking device arranged at an inlet end of the conveying device, and a second docking device arranged at an outlet end of the conveying device;
wherein the conveying device is configured to transfer target objects to be warehoused from an operation area to the inlet end and the outlet end of the conveying device;
the first docking device is configured to transfer the target object to be warehoused from the inlet end to the first handling device;
the second docking device is configured to transfer the target object to be warehoused from the outlet end to the second handling device; and
the first handling device and the second handling device are configured to transfer the target objects to be warehoused to a rack area.

29.-30. (canceled)

31. The system according to claim 1, wherein the handling device comprises a first handling device and a second handling device, the docking device comprises a first docking device arranged at an inlet end of the conveying device, and a second docking device arranged at an outlet end of the conveying device;
wherein the first handling device is configured to carry an empty order box and a target object to be picked to a first docking position, and transfer the empty order box and the target object to be picked to the first docking device at the first docking position;
the first docking device is configured to transfer the empty order box and the target object to be picked to the inlet end of the conveying device;
the conveying device is configured to transfer the empty order box and the target object to be picked from the inlet end to an operation area for picking goods from the target object into the empty order box in the operation area, and transfer a target object passing through the operation area to the outlet end of the conveying device; and
the second docking device is configured to transfer the target object from the outlet end to the second handling device,
optionally, the first handling device is configured to separately transfer the empty order box and the target object to be picked to the first docking device; or
the empty order box and the target object to be picked are transferred to the first docking device by two first handling devices, one of the two first handling devices transports the empty order box, and the other of the two first handling devices transports the target object to be picked.

32.-37. (canceled)

38. A warehouse, comprising: a warehousing area, a first storage area for storing a target object, a second storage area for storing a target object to be shipped out, an operation area and a shipping-out area;
wherein a handling device is configured to transfer the target object to be shipped out among target objects in the warehousing area to the second storage area, and transfer remaining target objects in the warehousing area other than the target object to be shipped out to the first storage area, according to a preset storage strategy;
the handling device is configured to transfer the target object to be shipped out from the second storage area to the operation area, wherein the operation area is deployed with at least one target object conveying system according to claim 1, and the target object conveying system is configured to perform picking of the target object to be shipped out to obtain a picked target object; and
the handling device is configured to transfer the picked target object to the shipping-out area.

39. A target object conveying method, applied to a target object conveying system comprising a handling device, a conveying device and a docking device arranged at an end of the conveying device, the method comprising:
transferring, by the docking device, a target object between the conveying device and the handling device, wherein the docking device is provided with a power transmission mechanism in a comb-tooth structure, the handling device has a top plate in a comb-tooth structure adapted to the power transmission mechanism to dock the top plate of the handling device with the power transmission mechanism; and
providing, by the conveying device, a conveying path for conveying the target object between the conveying device and an operation area.

40. The method according to claim 39, wherein transferring, by the docking device, the target object between the conveying device and the handling device comprises:
transferring the target object from the top plate to the power transmission mechanism by inserting the top plate into the power transmission mechanism at a docking position and lowering the top plate by a first preset height to transfer the target object from the top plate to the power transmission mechanism; or
transferring the target object from the power transmission mechanism to the top plate by inserting the top plate into the power transmission mechanism at a docking position and raising the top plate by a first preset height to transfer the target object from the power transmission mechanism to the top plate.

41.-42. (canceled)

43. The method according to claim 39, wherein transferring, by the docking device, the target object between the conveying device and the handling device comprises:
in a process where the handling device loaded with the target object to be transported moves towards the docking device, raising the top plate of the handling device to a second preset height, and transferring the target object to be transported from the top plate to the docking device at a docking position, wherein the second preset height is determined according to a height of the docking device; or
after the handling device loaded with the target object to be transported reaches a docking position, raising the top plate of the handling device to a second preset height, and transferring the target object to be transported from the top plate to the docking device at the docking position, wherein the second preset height is determined according to a height of the docking device;
optionally, in a case where it is determined that the second preset height is within a preset height range, the target object to be transported on the top plate is transferred to the docking device at the docking position; or
in a case where it is determined that the second preset height is greater than a maximum height in a preset height range, the top plate is lowered at the docking position to transfer the target object to be transported from the top plate to the docking device.

44.-45. (canceled)

46. The system according to claim 1, wherein the top plate of the handling device is provided with a first limiting assembly to present the target object from falling from the top plate; and
the power transmission mechanism is provided with a second limiting assembly, and the second limiting assembly is configured to limit a transfer path of the target object to be transported at the power transmission mechanism.

47.-50. (canceled)

51. The method according to claim 39, wherein the handling device comprises a first handling device and a second handling device, and the docking device comprises a first docking device arranged at an inlet end of the conveying device, and a second docking device arranged at an outlet end of the conveying device;
wherein the method comprises:
transporting, by the first handling device, a target object to be transported to a first docking position, and transferring the target object to be transported to the first docking device at the first docking position;
transferring, by the first docking device, the target object to be transported to the inlet end of the conveying device;
transferring, by the conveying device, the target object to be transported from the inlet end to an operation area for an picking operation of the target object in the operation area, and transferring the target object passing through the operation area to the outlet end of the conveying device; and
transferring, by the second docking device, the target object from the outlet end to the second handling device.

52. The method according to claim 39, wherein the handling device comprises a first handling device and a second handling device, the docking device comprises a first docking device arranged at an inlet end of the conveying device, and a second docking device arranged at an outlet end of the conveying device;
wherein the method comprises:
transferring, by the conveying device, target objects to be warehoused from an operation area to the inlet end and the outlet end of the conveying device;
transferring, by the first docking device, the target object to be warehoused from the inlet end to the first handling device;
transferring, by the second docking device, the target object to be warehoused from the outlet end to the second handling device; and
transferring, by the first handling device and the second handling device, the target objects to be warehoused to a rack area.

53. The method according to claim 39, wherein the handling device comprises a first handling device and a second handling device, the docking device comprises a first docking device arranged at an inlet end of the conveying device, and a second docking device arranged at an outlet end of the conveying device;
wherein the method comprises:
transporting, by the first handling device, an empty order box and a target object to be picked to a first docking position, and transferring the empty order box and the target object to be picked to the first docking device at the first docking position;
transferring, by the first docking device, the empty order box and the target object to be picked to the inlet end of the conveying device;
transferring, by the conveying device, the empty order box and the target object to be picked from the inlet end to an operation area for picking goods from the target object into the empty order box in the operation area, and transferring a target object passing through the operation area to the outlet end of the conveying device; and
transferring, by the second docking device, the target object from the outlet end to the second handling device.
